(19) United States
(12) Patent Application Publication
(10) Pub. No.: US 2001/0054172 A1
(43) Pub. Date: Dec. 20, 2001

(54) Serialization technique

(76) Inventor: Jeffrey Taihana Tuatini, San Francisco, CA (US)

Correspondence Address: PERKINS COIE LLP, PATENT-SEA, P.O. BOX 1247, SEATTLE, WA, 98111-1247, US

(21) Appl. No.: 09/753,038

(22) Filed: Dec. 28, 2000

Related U.S. Application Data
(60) Provisional application No. 60/173,955, filed on Dec. 30, 1999.
(60) Provisional application No. 60/173,663, filed on Dec. 3, 1999.

(51) Int. Cl. G06F 9/44

(52) U.S. Cl. 717/1

(57) ABSTRACT

A method and system for generating class definitions, XML serialization code, and validation logic from a XML document type definition (“DTD”) and associated enhanced syntax data. The generation is controlled by a schema compiler that includes a parser and a code generator. The parser inputs the XML DTD's and generates a syntax parse tree representation of the DTD's. The parser then annotates the syntax parse tree with enhanced syntax data. The code generator inputs the annotated syntax parse tree and generates the class definitions, the serialization code, and the validation logic.

### CROSS-REFERENCE TO RELATED APPLICATIONS

This application claims the benefit of U.S. patent application Ser. No. 60/173,955, entitled “SCHEMA COMPILER,” filed on Dec. 30, 1999 (Attorney Docket No. 243768002US), and U.S. patent application Ser. No. 60/173,663, entitled “MESSAGE VERIFICATION,” filed on Dec. 30, 1999 (Attorney Docket No. 243768010US); and is related to U.S. patent application Ser No. ______ , entitled “APPLICATION ARCHITECTURE,” filed on Dec. 28, 2000 (Attorney Docket No. 243768011 US01), the disclosures of which are incorporated herein by reference.

### TECHNICAL FIELD

The described technology relates to the serialization and deserialization of data.

### BACKGROUND

Many companies are now allowing their customers to remotely access the company computer systems. These companies believe that the providing of such access will give the company an advantage over their competitors. For example, they believe that a customer may be more likely to order from a company that provides computer systems through which that customer can submit and then track their orders. The applications for these computer systems may have been developed by the companies specially to provide information or services that the customers can remotely access, or the applications may have been used internally by the companies and are now being made available to the customers. For example, a company may have previously used an application internally to identify an optimum configuration for equipment that is to be delivered to a particular customer's site. By making such an application available to the customer, the customer is able to identify the optimum configuration themselves based on their current requirements, which may not be necessarily known to the company. The rapid growth of the Internet and its ease of use has helped to spur making such remote access available to customers.

Because of the substantial benefits from providing such remote access, companies often find that various groups within the company undertake independent efforts to provide their customers with access to their applications. As a result, a company may find that these groups may have used very different and incompatible solutions to provide remote access to the customers. It is well-known that the cost of maintaining applications over their lifetime can greatly exceed the initial cost of developing the application. Moreover, the cost of maintaining applications that are developed by different groups that use incompatible solutions can be much higher than if compatible solutions are used. Part of the higher cost results from the need to have expertise available for each solution. In addition, the design of the applications also has a significant impact on the overall cost of maintaining an application. Some designs lend themselves to easy and cost effective maintenance, whereas other designs require much more costly maintenance. It would be desirable to have an application architecture that would allow for the rapid development of new applications and rapid adaptation of legacy applications that are made available to customers, that would provide the flexibility needed by a group to provide applications tailored to their customers, and that would help reduce the cost of developing and maintaining the applications.

### BRIEF DESCRIPTION OF THE DRAWINGS

FIG. 1 is a block diagram illustrating the components of the schema compiler.

FIG. 2 is a flow diagram illustrating the overall processing of the parser component of the schema compiler.

FIG. 3 is a flow diagram illustrating the overall processing of the code generator component of the schema compiler.

FIG. 4 illustrates a table for mapping class types to serialization and validation code.

FIG. 5 is a flow diagram illustrating the processing of a service request routine in one embodiment.

### DETAILED DESCRIPTION

A method and system for generating class definitions, XML serialization code, and validation logic from a XML document type definition (“DTD”) and associated enhanced syntax data is provided. In one embodiment, the generation is controlled by a schema compiler that includes a parser and a code generator. The parser inputs the XML DTD's and generates a syntax parse tree representation of the DTD's. The parser then annotates the syntax parse tree with enhanced syntax data. The code generator inputs the annotated syntax parse tree and generates the class definitions, the serialization code, and the validation logic.

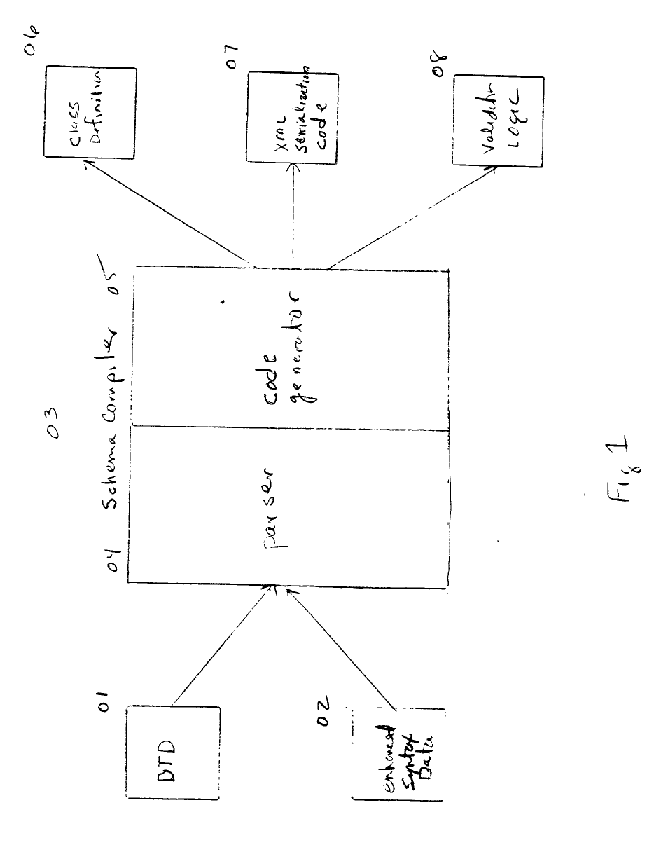

FIG. 1 is a block diagram illustrating the components of the schema compiler. The schema compiler 103 inputs DTD's 101 and enhanced syntax data 102. The DTD's are specified in accordance with the Extensible Markup Language (XML) 1.0 as defined by the Worldwide Web Consortium (“W3C”). The definition of XML is available at “HTTP://www.w3c.org/TR/REC-xml” and is hereby incorporated by reference. The XML is a markup language for documents that contain structure information. As such, it is a mechanism to identify structures in a document (e.g., an HTML document) in a standard manner. The DTD's of a document provide meta data that is used by a parser when parsing the document. The meta data includes allowed sequence and nesting of tags, attribute values, names of external files that may be referenced, the formats of external data that may be referenced, and entities that may be encountered. The enhanced syntax data contains additional information that cannot be specified by XML DTD's. The enhanced syntax data may include more detailed information on the type of data within the document. For example, a DTD may specify that one type of data is of character type, whereas the enhanced syntax data may specify that the characters must be a valid integer. In addition, the enhanced syntax data may provide references to external functions that may be used to validate or provide certain behavior associated with a type of data. The schema compiler includes a parser 104 and a code generator 105. The parser may include a conventional parser, such as the Document Object Model parser, for generating the initial syntax parse tree. The parser includes an annotation component for annotating the initial syntax parse tree based on the enhanced syntax data.

The code generator generates a class definition (e.g., a JAVA class or a C++ class) for each element specified by a DTD. Each class of an element contains data members that correspond to the sub-elements and attributes of that element. In addition, the class defines member functions for setting and getting each data member. For example, if an element contains a sub-element, then the element includes a function for retrieving a pointer to an object representing the sub-element. The code generator also generates serialization and de-serialization code for each element. The de-serialization code inputs a document specified using XML and outputs an object that is an instance of a class definition generated by the schema compiler for the element representing that document. The de-serialization code maps the data of the XML document to the object. The serialization code operates in the reverse direction to generate an XML document from an object. The schema compiler also generates validation logic. The validation logic inputs an object of a certain class definition and outputs an indication as to whether the object is valid. For example, the validation logic may ensure that sub-objects representing required sub-elements are present in the object. The validation logic may also performed custom validation as specified by the enhanced syntax data.

Table 1 illustrates an example document type definition (“DTD”). This DTD defines an “order query” element of a document. The order query element has one sub-element named “order.” The order sub-element contains no sub elements. The order sub-element, however, has an attribute named “num.” That attribute is of type character data as indicated by the “CDATA” type.

TABLE 1
Document Type Declaration

<!ELEMENT orderquery (order)>
<!ELEMENT order empty>
<!ATTLIST order
num CDATA>

Table 2 illustrates example enhanced syntax data. This enhanced syntax data is associated with the order element as defined in Table 1. The enhanced syntax data indicates that the num attribute is an integer. The enhanced syntax data in one embodiment is specified using XML. The enhanced syntax data can specify type of information to augment the DTD's. The enhanced syntax data may specify a validation routine for providing validation of an element. For example, if the element represents an order, then the validation routine may check an order database to ensure that an order with the specified order number is in the database.

TABLE 2
Meta Data

<Element name = order>
ElementType> integer </ElementType>
<Element>

Table 3 illustrates an example order query message. The format of the message is defined by the DTD's of Table 1. In this example, the message starts with an order query start tag “<orderquery>” and ends with an order query end tag “</orderquery>.” The order query element contains the order sub element “<order num=” 0001“>.”

TABLE 3
MSG

<orderquery>
<order num = “0001”
</orderquery>

Table 4 illustrates example pseudo-code of class definitions generated by the schema compiler. The schema compiler generates a class for the order query element and for the order element. The order query class contains a data member that points to the sub-object representing the order sub-element and includes member functions for setting that data member and retrieving the value of that data member. The order class contains a data member corresponding to the attribute num and member functions for setting the value of that attribute and for retrieving the value of that attribute.

TABLE 4
class orderquery {

porder *order
Set.order (pord *order) {porder = pord};
*order Get.order ( ){return (porder)};

}
class order {

num cdata;
Set.num(n integer){num = n};
cdata Get.num( ){return(num)};

}

Table 5 illustrates an example pseudo-code of a validation function generated by the schema compiler. This validation function is for validating an object corresponding to an order element. This validation function inputs a pointer to the order object and returns an indication as to whether that order object is valid. In this example, the only validation performed is to ensure that the value in the attribute num is numeric. As discussed above, the validation performed can be based on the DTD's themselves or on the enhanced syntax data. For example, a validation for required elements may be indicated by a DTD, and a validation for presence in a database may be indicated by the enhanced syntax data.

TABLE 5
boolean function validate.order (porder order)
{

num = porder->Get.num( );
return (numeric(num));

}

Table 6 illustrates example serialization and de-serialization functions generated by the schema compiler. The serialization function for a order query object retrieves a pointer to its sub-object and then requests its sub-object to serialize itself. In this example, the order sub-object writes out the value of its num attribute to an output stream. The de-serialization functions worked in analogous manner.

TABLE 6
function serialize.orderquery (porderquery *orderquery, out stream) {

porder = porderquery−>Get.order();
serialize.order (porder, out);

}
function serialize.order (porder *order, out stream) {

write (out, porder−>num);

}
function deserialize.orderquery (porderquery *orderquery, in stream) {

porder = createinstance (order);
deserialize.order (porder, in);

}
function deserialize.order (porder *order, in stream) {

porder−>num = read (in);

}

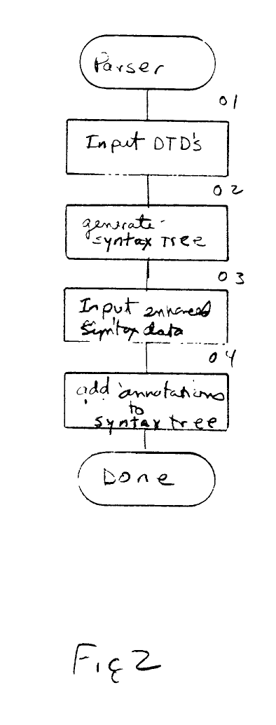

FIG. 2 is a flow diagram illustrating the overall processing of the parser component of the schema compiler. In block 201, the parser inputs the DTD's. In block 202, the parser generates a syntax tree corresponding to be DTD's. Parsers are described in “Compilers: Principles, Techniques, and Tools,” by Aho, Sethe, and Ullnan, which is hereby incorporated by reference. The syntax tree is a tree data structure that describes the syntax of the DTD's. In block 203, the parser inputs the enhanced syntax data. In block 204, the parser annotates the syntax tree with the enhanced syntax data. This annotation may be in the form of storing pointers in the node of the syntax tree that define special validation or type information for the element represented by the node.

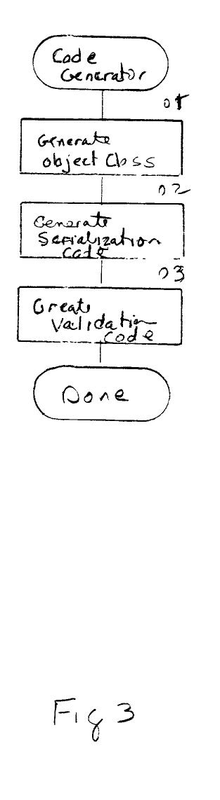

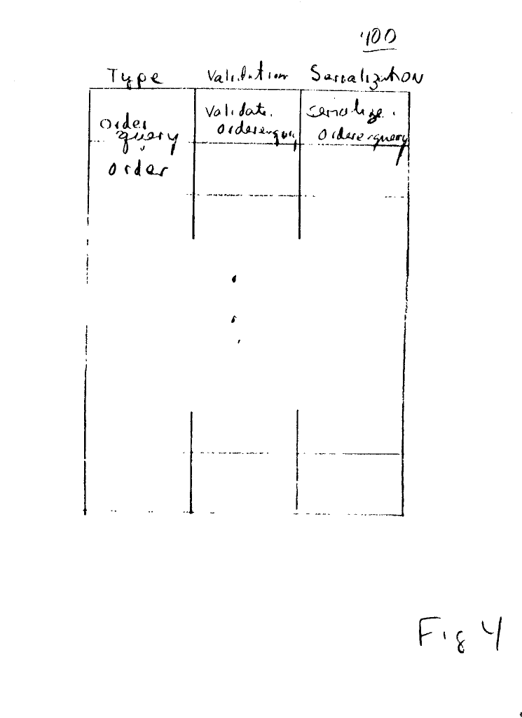

FIG. 3 is a flow diagram illustrating the overall processing of the code generator component of the schema compiler. The code generator inputs the syntax parse tree generated by the parser. In block 301, the code generator generates an object class definition for each element represented by the syntax parse tree. The class for an element includes a data member for each attribute of that element and for each sub-element. In addition, the class includes a set and get member function for each data member. In block 302, the code generator generates serialization and de-serialization code for each class defined in block 301. In block 303, the code generator generates validation code for each class defined in block 301. The code generator may store references to the serialization and validation code in type mapping table as shown in FIG. 4. Table 400 includes an entry for each element type. Each entry identifies the name of the type and includes a reference to the validation code and serialization and de-serialization code.

The separation of serialization and validation code from the class definitions have several advantages. In particular, the separation allows the validation and serialization to be performed by an entity external to an application program that uses the data of the classes. Also, this separation allows the serialization and validation code to be modified without affecting the applications that access the data of the classes. In one embodiment, a message (e.g., defined as an XML document) is processed by a generic service request routine. This generic service request routine uses the generated de-serialization code to de-serialize the message to generate an object representing that message. The service request routine then validates the data of that object using the generated validation logic. If the object is valid, then the service request routine decodes the service (e.g., order processing) represented by that message and decodes the function (e.g., order query) represented by that message. The service request routine then invokes an order query processing component of the order system. The service request routine passes an order query object, which encodes the information defining the service that is requested. The service request routine may return an order query response object to the service request routine. The service request routine may serializes the information of the order query response object and send the serialized information to the requesting entity.

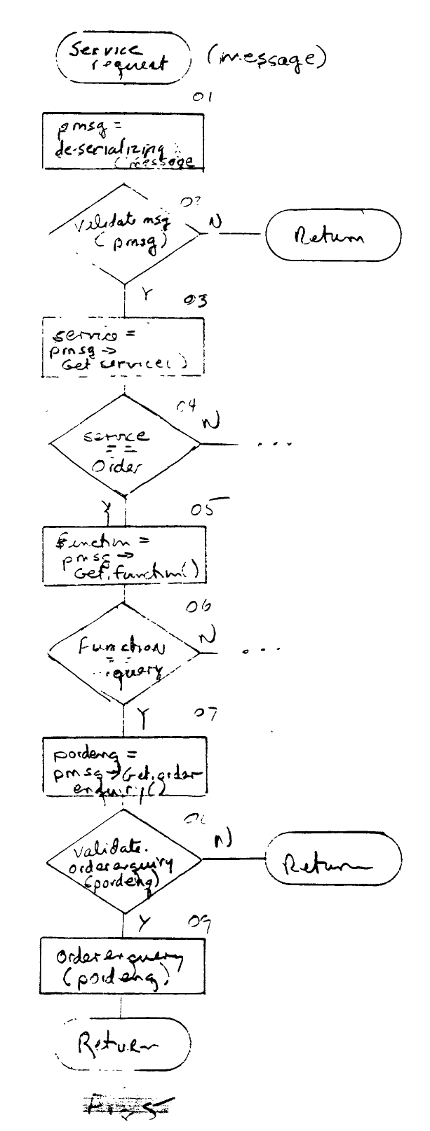

FIG. 5 is a flow diagram illustrating the processing of a service request routine in one embodiment. The service request routine is passed a serialized message and may return a serialized response message. In block 501, the routine de-serializes the message into a message object by invoking the de-serialize code generated by the schema compiler. In block 501, if the message is valid as indicated by invoking the validate code for the class of the message as generated by the schema compiler, then the routine continues at block 503, else the routine returns an error. In block 503, the routine retrieves a service attribute from the message by invoking a get service function. In block 503, if the service indicates that the message is for the order system, then the routine continues at block 505, else the routine continues to decode the service. In block 505, the routine retrieves the function attribute from the message by invoking a get function function. In block 506, if the function corresponds to a query, then the routine continues at block 507, else the routine continues to decode the function. In block 507, the routine retrieves an object that corresponds to the order query sub-element of the message by invoking the get order function. In block 508, if the order query object is valid, then the routine continues at block 509, else the routine returns. In block 509, the routine invokes the order query sub-system of the order system and the returns. If the order query sub-system returns a response message, then the routine serializes that message and returns it.

1. A method in a computer system for serializing data, the method comprising:
generating an enhanced syntax parse tree from a document type definition and enhanced syntax data;
generating a class definition and serialization code based on the generated enhanced syntax parse tree;
receiving from an application a serialization request for data defined by the document type definition; and
in response to receiving the serialization request,
when the serialization request indicates to deserialize the data, invoking the generated serialization code passing the data in serialized form and receiving an object of the generated class definition representing the passed data in deserialized form; and
when the serialization request indicates to serialize the data, invoking the generated serialization code passing an object of the generated class definition, the object representing the data in deserialized form, and receiving the data in serialized form.

2. The method of claim 1 including generating validation code based on the enhanced syntax parse tree and invoking the validation code to validate data defined by the document type definition.

3. The method of claim 1 wherein the enhanced syntax data includes validation information for data of the document type definition.

4. The method of claim 1 including generating a mapping of the serialization code to the document type definition.

5. The method of claim 1 wherein the serialization code may be modified without modifying the application.

6. A method in a computer system for deserializing data, the method comprising:
receiving a class definition and serialization code for a document of a type;
receiving from an application a request to deserialize data in serialized form, the data being defined by the type; and
in response to receiving the request to deserialize data,
identifying deserialization code for the type of the data; and
invoking the identified serialization code passing the data in serialized form and receiving an object of the received class definition representing the data in deserialized form.

7. The method of claim 6 including
receiving from an application a request to serialize the data in deserialized form being represented by an object of the received class definition; and
in response to receiving the request to serialize the data,
identifying serialization code for the type of data; and
invoking the identified serialization code passing the object representing the data in deserialized form and receiving the data in serialized form.

8. The method of claim 6 wherein the received class definition and serialization code are generated based on enhanced syntax parse tree derived from the type of the data and enhanced syntax data.

9. The method of claim 6 wherein the type of data is specified by a document type definition.

10. The method of claim 6 wherein the type of data is specified by an XML document type definition.

11. The method of claim 6 including receiving validation code for data of the type and invoking the validation code to validate the data.

12. The method of claim 11 wherein the validation code may be modified without modifying the application.

13. The method of claim 6 wherein the deserialization code may be modified without modifying the application.

14. A method in a computer system for serializing data, the method comprising:
receiving a class definition and serialization code for a document of a certain type;
receiving from an application a request to serialize data in deserialized form being represented by an object of the received class definition; and
in response to receiving the request to serialize the data,
identifying serialization code for the type of data; and
invoking the identified serialization code passing the object representing the data in deserialized form and receiving the data in serialized form.

15. The method of claim 14 wherein the received class definition and serialization code are generated based on enhanced syntax parse tree derived from the type of the data and enhanced syntax data.

16. The method of claim 14 wherein the type of data is specified by an XML document type definition.

17. The method of claim 14 including receiving validation code for data of the type and invoking the validation code to validate the data.

18. The method of claim 17 wherein the validation code may be modified without modifying the application.

19. The method of claim 14 wherein the serialization code may be modified without modifying the application.

20. A computer system for providing serialization services, comprising:
an application for processing different types of messages;
a class definition and serialization code for each type of message; and
a serialization component that receives a message to be processed by the application, identifies the type of the received message; and invokes the serialization code for the identified type of message
whereby the serialization is performed independently of the application.

21. The computer system of claim 20 wherein the serialization code serializes data represented by an object that is an instance of the class definition.

22. The computer system of claim 20 wherein the serialization code deserializes data into an object that is an instance of the class definition.

23. The computer system of claim 20 wherein the type of message is specified by an XML document type definition.

24. The computer system of claim 20 including validation code for each type of message and wherein the serialization component invokes validation code for the identified type of message.

25. A computer system for providing validation services, comprising:
an application for processing different types of messages;
a class definition and validation code for each type of message; and
a validation component that receives a message to be processed by the application, identifies the type of the received message; and invokes the validation code for the identified type of message
whereby the validation is performed independently of the application.

26. The computer system of claim 25 wherein validation code is passes the data in deserialized form.

27. The computer system of claim 25 including serialization code for each type of message and a serialization component that invokes the serialization code for the identified type of message.

28. A computer system for providing serialization services, comprising:
means for processing different types of messages;
means for defining a class definition and serialization code for each type of message; and
means for serializing messages to be processed by the means for processing by identifying the type of the received message and invoking the serialization code for the identified type of message
whereby the serialization is performed independently of the means for processing.

29. A computer-readable medium containing instructions for controlling a computer system to provide serialization services, by a method comprising:
receiving a class definition and serialization code for document of a certain type;
receiving from an application a request relating to serialization of data, deserialized data being represented by an object of the received class definition; and
in response to receiving the request,
identifying serialization code for the type of data; and
invoking the identified serialization code to perform serialization relating to the object representing the data in deserialized form and the data in serialized form.

30. The computer-readable medium of claim 29 wherein the received class definition and serialization code are generated based on enhanced syntax parse tree derived from the type of the data and enhanced syntax data.

31. The computer-readable medium of claim 29 wherein the type of data is specified by a document type definition.

32. The computer-readable medium of claim 29 including receiving validation code for data of the type and invoking the validation code to validate the data.

33. The computer-readable medium of claim 32 wherein the validation code may be modified without modifying the application.
